(19) United States
(12) Patent Application Publication
(10) Pub. No.: US 2021/0339900 A1
(43) Pub. Date: Nov. 4, 2021

(54) HANDHELD RAPID HEATING DEVICE FOR CUTTING AND ADHERING THIN FILM

(71) Applicant: Richard CHANG, New Taipei City (TW)

(72) Inventor: Richard CHANG, New Taipei City (TW)

(21) Appl. No.: 17/241,115

(22) Filed: Apr. 27, 2021

(30) Foreign Application Priority Data
May 1, 2020 (TW) 109114728

(51) Int. Cl. B65B 53/02; B65B 61/06

(52) U.S. Cl. CPC B65B 53/02; B65B 61/06

(57) ABSTRACT

The present invention provides a handheld rapid heating device for cutting and adhering a thin film, which includes a housing, a power supply module, and an electric heating module. The housing is formed with an opening. The power supply module is arranged in the housing. The electric heating module receives power from the power supply module, and includes an electrically heating wire. The electrically heating wire extends at least partially out of the opening of the housing, and is configured to he suitable for heating and thus melting an area of at least one thin film.

### CROSS REFERENCE TO RELATED APPLICATION

This application claims the benefits of the Taiwan Patent Application Serial Number 109114728, filed on May 1, 2020, the subject matter of which is incorporated herein by reference.

### BACKGROUND OF THE INVENTION

### 1. Field of the Invention

The present invention relates to a handheld rapid heating device fir cutting and adhering thin films and, more particularly, to a device that can instantly finish the cutting and the heat sealing by heating and melting the thin films.

### 2. Description of Related Art

FIG. 1 shows a schematic diagram of an electrically heating pen 9 of the prior art.

Generally, it includes a pen holder 910 and a pen head 920 in appearance. The pen head 920 is capable of heating up for gold-stamping or heat sealing.

However, the pen head 920 of the heating pen 9 of the prior art is of rectangular shape, so the heating area is very large. This may cause a big rift, and thus cannot form a fine sealing line. Therefore, it is unlikely to rapidly seal a plastic bag. Moreover, during the heat sealing, some solid, liquid, or gaseous materials stored in the plastic bag may leak out from the big rift; furthermore, the user has to adjust the relative position between the plastic bag and the heating pen so that the user can finish the heat sealing in a fluent way.

On the other hand, the heating pen 9 of the prior art has a switch 930 disposed on the housing of the pen holder 910. The user has to manually turn on the switch 930 before using it, and has to manually turn off the switch 930 after using it, so it is quite inconvenient. In addition, for the heating pen 9 of the prior art, the power supply relies on an electrical wiring 940.

Therefore, it is desirable to provide a device that can instantly finish cutting and heat sealing by heating and melting thin films to mitigate and/or obviate the aforementioned problems.

### SUMMARY OF THE INVENTION

In this regard, one aspect of the present invention is to provide a handheld rapid heating device for cutting and adhering a thin film, which includes a housing, a power supply module, and an electric heating module. The housing is formed with an opening. The power supply module is arranged in the housing. The electric heating module receives power from the power supply module, and includes an electrically heating wire. The electrically heating wire extends at least partially out of the opening of the housing, and is configured to be suitable for heating and thus melting an area of at least one thin film.

Optionally or preferably, a power of the electrically heating wire is set to provide a heating temperature that allows the melting area being cooled down and sealed in 1±0.5 seconds.

Optionally or preferably, the power of the electrically heating wire is in a range of 3 W to 7 W.

Optionally or preferably, a voltage of the electrically heating wire is in a range of 2.4 V to 6.0 V.

Optionally or preferably, the electrically heating wire is a round wire or a flat wire; a diameter of the round wire is in a range of 0.16 mm to 0.36 mm, and a diameter of the flat wire is in a range of 0.4 mm to 1.4 mm.

Optionally or preferably, a length of the electrically heating wire is inversely proportional to square of the diameter of the wire. In particular, a length of the electrically heating wire is 30±10 mm.

Optionally or preferably, the housing comprises a lower housing, and/or an upper housing, and/or a front housing, and/or a front lid. In addition, any combination of the lower housing, the upper housing, the front housing, or the front lid is integrally formed. Moreover, the lower housing and the upper house may constitute a rear housing module; the front housing and the front lid may constitute a front housing module, and the front housing module may be removably installed on the rear housing module.

Optionally or preferably, the housing comprises a retractable structure to let the electrically heating wire of the electric heating module move out of or move back into the opening of the housing.

Optionally or preferably, the power supply module is a one-time battery cell, or a rechargeable battery cell, or a linear power supply circuit, a switch power supply circuit, or a programming power supply circuit that are connected to an outer power supply in a wire or wireless way.

Optionally or preferably, the handheld rapid heating device for cutting and adhering a thin film further comprises a first connection piece, connected to a first end of the power supply module; and a second connection piece, connected to a second end of the power supply module, wherein the second connection piece is directly or indirectly connected to the electric heating module. In particular, in order to connect the side-by-side batteries in series, the first connection piece may be a double-contact piece, connected to the first end and a third end of the power supply module; the second connection piece may be a single-contact piece, connected to the second end and a fourth end of the power supply module.

Optionally or preferably, the handheld rapid heating device for cutting and adhering a thin film further comprises a switch spring, connected between the power supply module and the electric heating module and turning on or turning off the power of the electric heating module according to a pressure passing through the electrically heating wire. In particular, the switch spring may have a trigger pressure, and when a pressure passing through the electrically heating wire is higher than the trigger pressure, the power becomes enabled to supply to the electric heating module. As such, the trigger pressure of the switch spring may be 80 cN±25 cN.

Optionally or preferably, the handheld rapid heating device for cutting and adhering a thin film further comprises a switch, disposed on the housing and connected between the power supply module and the electric heating module.

Optionally or preferably, the handheld rapid heating device for cutting and adhering a thin film is a handheld one or a portable one. The maximum length is in a range of 80 mm to 140 mm, and the maximum width is in a range of 40 mm to 80 mm.

Other objects, advantages, and novel features of the invention will become more apparent from the following detailed description when taken in conjunction with the accompanying drawings.

### BRIEF DESCRIPTION OF THE DRAWINGS

FIG. 1 is a schematic diagram of a heating pen of the prior art;

FIG. 2 is an exploded view of the handheld rapid heating device for cutting and adhering a thin film, according to an embodiment of the present invention;

FIG. 3 is a perspective view of the handheld rapid heating device for cutting and adhering a thin film, according to an embodiment of the present invention,

FIG. 4 is an exploded view of the handheld rapid heating device for cutting and adhering a thin film, according to another embodiment of the present invention;

FIG. 5 is a perspective view of the handheld rapid heating device for cutting and adhering a thin film, according to another embodiment of the present invention; and

FIG. 6 is a schematic diagram of the operation of the handheld rapid heating device for cutting and adhering a thin film, according to an embodiment of the present invention.

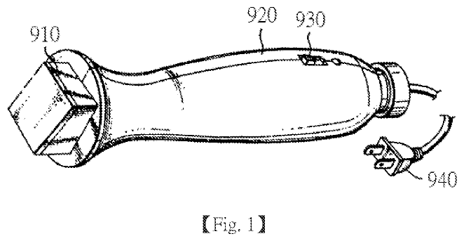

### DETAILED DESCRIPTION OF THE EMBODIMENT

Different embodiments of the present invention are provided in the following description. These embodiments are meant to explain the technical content of the present invention, but not meant to limit the scope of the present invention. A feature described in an embodiment may be applied to other embodiments by suitable modification, substitution, combination, or separation.

It should be noted that, in the present specification, when a component is described to have an element, it means that the component may have one or more of the elements, and it does not mean that the component has only one of the element, except otherwise specified.

Moreover, in the present specification, the ordinal numbers, such as “first” or “second”, are used to distinguish a plurality of elements having the same name, and it does not means that there is essentially a level, a rank, an executing order, or an manufacturing order among the elements, except otherwise specified. A “first” element and a “second” element may exist together in the same component, or alternatively, they may exist in different components, respectively. The existence of an element described by a greater ordinal number does not essentially means the existent of another element described by a smaller ordinal number.

In the present specification, the so-called feature A “or” or “and/or” feature B means A exists solely, B exists solely, or A and B exist at the same time; the so-called feature A “and” feature B means A and B exist at the same time; the so-called “include”, “comprise”, “have”, or “contain” refers to include, but are not limited thereto, except otherwise specified.

Moreover, in the present specification, the terms, such as “top”, “bottom”, “left”, “right”, “front”, “back”, or “middle”, as well as the terms, such as “on”, “above”, “under”, “below”, or “between”, are used to describe the relative positions among a plurality of elements, and the described relative positions may be interpreted to include their translation, rotation, or reflection.

Moreover, in the present specification, when an element is described to be arranged “on” another element, it does not essentially means that the elements contact the other element, except otherwise specified. Such interpretation is applied to other cases similar to the case of “on”.

Moreover, in the present specification, the terms, such as “preferably” or “advantageously”, are used to describe an optional or additional element or feature, and in other words, the element or the feature is not an essential element, and may be ignored in some embodiments.

Moreover, in the present specification, when an element is described to be “suitable for” or “adapted to” another element, the other element is an example or a reference helpful in imagination of properties or applications of the element, and the other element is not to be considered to form a part of a claimed subject matter; similarly, except otherwise specified; similarly, in the present specification, when an element is described to be “suitable for” or “adapted to” a configuration or an action, the description is made to focus on properties or applications of the element, and it does not essentially mean that the configuration has been set or the action has been performed, except otherwise specified.

Moreover, in the present specification, the terms, such as “system”, “apparatus”, “device”, “module”, or “unit”, refer to an electronic element, or a digital circuit, an analogous circuit, or other general circuit, composed of a plurality of electronic elements, and there is not essentially a level or a rank among the aforementioned terms, except otherwise specified.

Moreover, in the present specification, two elements may be electrically connected to each other directly or indirectly, except otherwise specified. In an indirect connection, one or more elements, such as resistors, capacitors, or inductors may exist between the two elements. The electrical connection is used to send one or more signals, such as DC or AC currents or voltages, depending on practical applications.

Moreover, a terminal or a server may include the aforementioned element(s), or be implemented in the aforementioned manner(s).

Moreover, in the present specification, a value may be interpreted to cover a range within ±10% of the value, and in particular, a range within ±5% of the value, except otherwise specified; a range may be interpreted to be composed of a plurality of subranges defined by a smaller endpoint, a smaller quartile, a median, a greater quartile, and a greater endpoint, except otherwise specified.

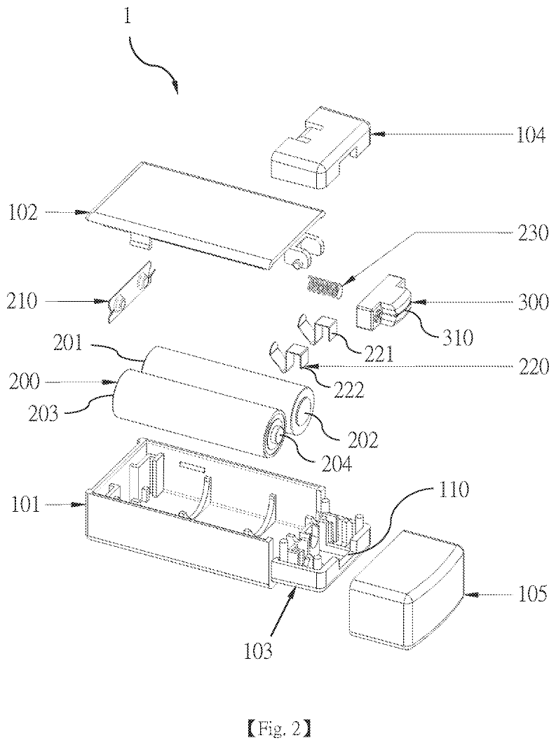

FIG. 2 is an exploded view of the handheld rapid heating device 1 for cutting and adhering a thin film, according to an embodiment of the present invention.

The handheld rapid heating device 1 for cutting and adhering a thin film of the present invention mainly includes a housing 100, a power supply module 200, and an electric heating module 300.

The housing 100 is formed with an opening 110. Specifically, the housing 100 may include a lower housing 101, an upper housing 102, a front housing 103, and/or a front lid 104. In addition, any combination of the lower housing 101, the upper housing 102, the front housing 103, or the front lid 104 may be integrally formed. For sure, they can be screwed with each other, engaged with each other, or adhered to each other by glue. In the embodiment illustrated in FIG. 2, the lower housing 101 and the front housing 103 are integrally formed. Moreover, the upper housing 102 serves as a battery cell lid, but not limited thereto. The housing 100 may be made by plastic, so as to be lightweight, but it may be made by other materials, such as metal, in consideration of its stability or visual texture. In addition to adapting the technique of die casting, the housing 100 may be made by adopting 3D printing technologies as well.

In addition, in certain embodiments (not illustrated), the housing 100 may include a retractable structure. When a user pushes the switch, an electrically heating wire 310 of the electric heating module 300 can move out of or move back into the opening 110 of the housing 100.

A power supply module 200 is arranged in the inner space of the housing 100. The power supply module 200 may be a one-time battery cell or a rechargeable battery cell. The cells are mainly AA or AAA type. For sure, it is also possible to employ an outer power supply instead of the battery cell. In this circumstance, the power supply module 200 may be a linear power supply circuit, a power switch circuit, or a programming power supply circuit and connected to an outer power supply in a wire or wireless way. Those circuits may have an AC/DC switch, and can therefore supply the required current or voltage.

The electric heating module 300 receives the power from the power supply module 200. It includes an electrically heating wire 310. The electrically heating wire 310 at least partially extends out to the opening 110 of the housing 100 to heat and melt an area of at least one thin film. The at least one thin film can be a plastic thin film, two pieces of thin films (a front thin film and a rear thin film) overlapping each other when a plastic bag is folded, or multiple layers of thin films. Generally, the so-called thin film can be referred to any kinds of thin films as long as they can be melted by the electrically heating wire 310 for cutting.

Regarding the electrically heating wire 310, its power is set to provide a heating temperature that allows the melting area of the thin film being cooled down and sealed in 1±0.5 seconds, so that the heat sealing can be finished rapidly, so as to prevent solid, liquid, or gaseous materials that stored in the thin film from leaking out. The temperature mentioned above can be in a range of 120° C. to 350° C. and, particularly, in a range of 120° C. to 150° C., so that both of the melting and the heat sealing can be realized in a better way. ° C. means Celsius temperature.

In order to reach the temperatures mentioned above that can rapidly finish the heat sealing, the power of the electrically heating wire 310 is preferably in a range of 3W to 7W and, more preferably, is 3W. In the present invention, the setting of the power is very important, since only an extremely small rift is allowed to be formed, so as to quickly seal the thin film. In addition, the proper setting of the power can save a pre-heating time, and the user does not have to wait it. Accordingly, a voltage of the electrically heating wire 310 can be set in a range of 2.4V to 6.0V and, preferably, in a range of 2.4V to 3.0V. The electrically heating wire 310 can be a round wire or a flat wire. If the electrically heating wire 310 is a round wire, a diameter of the round wire can be in a range of 0.16 mm to 0.36 mm, and preferably, can be 0.23 mm to 0.34 mm. If the electrically heating wire 310 is a flat wire, a diameter of the flat wire can be in a range of 0.4 mm to 1.4 mm, and preferably, can be 0.6 mm. The length of the electrically heating wire 310 is inversely proportional to the square of the diameter of the electrically heating wire 310. Specifically, the length of the electrically heating wire 310 can be set in a range of 30 mm±10 mm. Apparently, based on physical principles, to scale up or scale down the aforementioned numbers can be made, without departing from the spirit and scope of the invention.

It is interesting to note that, since the power of the electrically heating wire 310 is set to provide a heating temperature that can instantly heat up and thus melt an area of a thin film and then the melting area of the thin film can be cooled down and sealed in 1±0.5 seconds, the user can take the handheld rapid heating device 1 for cutting and adhering a thin film of the present invention and easily and fluently scratch across the thin film (from one side of the thin film to the other side) without much effort to favorably finish the heat sealing. Since the electrically heating wire 310 of the present invention is highly effective, the user may consider lying a mat (or two pieces of papers for example) under or at the rear side of the plastic thin film, to protect any other objects. Even, when the user uses the handheld rapid heating device 1 for cutting and adhering a thin film of the present invention, even though scratching across the part of the plastic bag that is filled with some solid, liquid, or gaseous materials, those solid, liquid, or gaseous materials will not leak out. It is clear that the handheld rapid heating device 1 for cutting and adhering a thin film of the present invention is convenient and highly effective. Those effects have been proved by experiments.

In order to let the power supply module 200 supply electric power to the electric heating module 300, the handheld rapid heating device 1 for cutting and adhering a thin film of the present invention may further include a first connection piece 210 and a second connection piece 220. In the embodiment of FIG. 2, the first connection piece 210 is a double-contact piece, connected to a first end 201 and a third end 203 of the power supply module 200. The two points of the double-contact piece are electrically connected to each other, so they can be connected to two batteries. The second connection piece 220 is a single-contact piece, connected to a second end 202 and a fourth end 204 of the power supply module 200. The electrically heating wire 310 of the electric heating module 300 is connected to the two connection points 221, 222 in the middle of the second connection piece 220. Accordingly, an electrical circuit loop can be formed. According to the aforementioned principle of the present invention, single-contact piece and/or double-contact piece can be used to be connected to more batteries in series or in parallel.

Next, the handheld rapid heating device 1 for cutting and adhering a thin film of the present invention may further include a switch spring 230, electrically connected to the power supply module 200 and the electric heating module 300, and turning on or turning off the power of the electric heating module 300 according to a pressure passing through the electrically heating wire 310. Referring to FIG. 2, when the user presses the handheld rapid heating device 1 for cutting and adhering a thin film of the present invention on the thin films (the thin films are typically placed on a plane such as on a table), the electrically heating wire 310 will be forced to move toward the power supply module 200 to press the switch spring 230; next, the switch spring 230 makes the second connection piece 220 (particularly the connection point 221) contact the second end 202 of the power supply module 200, so as to form a closed loop. Therefore the housing 100 for the handheld rapid heating device 1 for cutting and adhering a thin film of the present invention does not need a dedicated switch (set as the switch 930 of the prior art), but the pressing action can directly provide the function of the switch. Thus, it is very convenient. However, in order to avoid any accidental touch, the switch spring 230 can be set to have a trigger pressure, and when a pressure passing through the electrically heating wire is higher than the trigger pressure, the power becomes enabled to supply to the electric heating module 300. Specifically, the trigger pressure of the switch spring is 80cN±25cN. The cN herein stands for centinewton.

In addition, the handheld rapid heating device 1 for cutting and adhering a thin film of the present invention may further include a protection lid 105, removeably covering on the front part housing 103 and the front lid 104 to protect the electrically heating wire 310 of the electric heating module 300 from a physical damage or a chemical erosion, and also, to avoid an accidental touch.

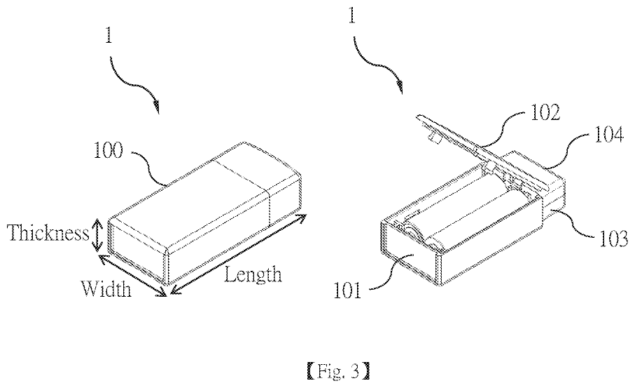

FIG. 3 is a perspective view of the handheld rapid heating device 1 for cutting and adhering a thin film and a view showing its open state, according to an embodiment of the present invention.

The handheld rapid heating device 1 for cutting and adhering a thin film of the present invention may be a handheld one or a portable one, and, preferably, is one that can be stored in a pocket. For example, it can be one as small and light as a lighter. Specifically, the maximum length is in a range of 80 mm to 140 mm, the maximum width is in a range of 40 mm to 80 mm, and the maximum thickness is in a range of 20 mm to 40 mm.

In addition, as shown in FIG. 3, a rotation axis can be provided between the upper housing 102 and the front housing 104 so that the upper housing 102 can be opened through the rotation, especially when the user wants to change the batteries.

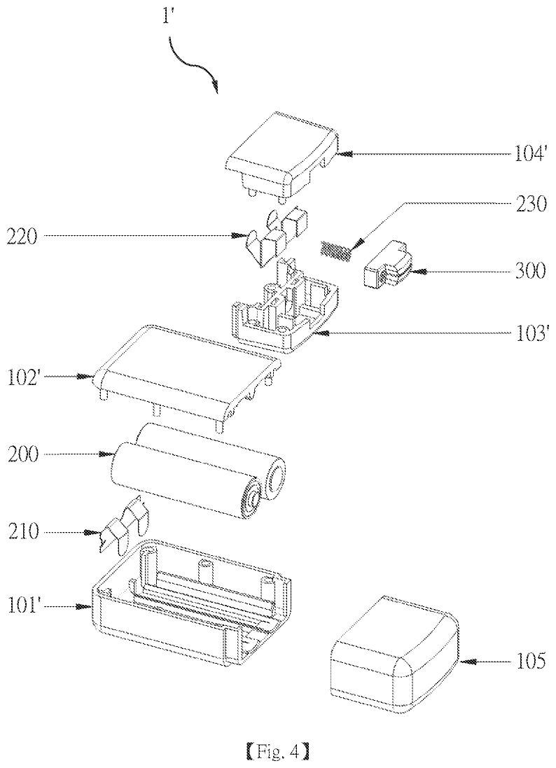

FIG. 4 is an exploded view of the handheld rapid heating device 1′ for cutting and adhering a thin film, according to another embodiment of the present invention. FIG. 5 is a perspective view of the handheld rapid heating device for cutting and adhering a thin film and a view showing its open state, according to another embodiment of the present invention.

As shown in FIG. 4, in this embodiment, the housing 100′ of the handheld rapid heating device 1′ for cutting and adhering a thin film includes a lower housing 101′, an upper housing 102′, a front housing 103′ and a front lid 104′. The lower housing 101′ and the upper housing 102′ are engaged with each other through inserts and holes, and thus to form a rear housing module; the front housing 103′ and the front lid 104′ are also engaged with each other through inserts and holes, and thus to form a front housing module. Note that the first connection piece in FIG. 4 (i.e. the double-contact piece 210) is a bit different from the first connection piece in FIG. 2 (i.e. the double-contact piece 210), but their functions are the same.

Next, mainly with reference to FIG. 5, the rear housing module, composed of the lower housing 101′ and the upper housing 102′, and the front housing module, composed of the front housing 103′ and the front lid 104′, are engaged with each other through a recess and a protrusion. Thus, the user can open the front housing module to change the batteries contained in the rear housing module. In addition, the front housing module and the electrically heating wire stored therein can be modularized, so this allows the user to choose different power electrically heating wires for different thin films made with different thickness or by different materials. Furthermore, when the electrically heating wire is aging or malfunctioned, the removable front housing module can be removed and replaced by a new front housing module.

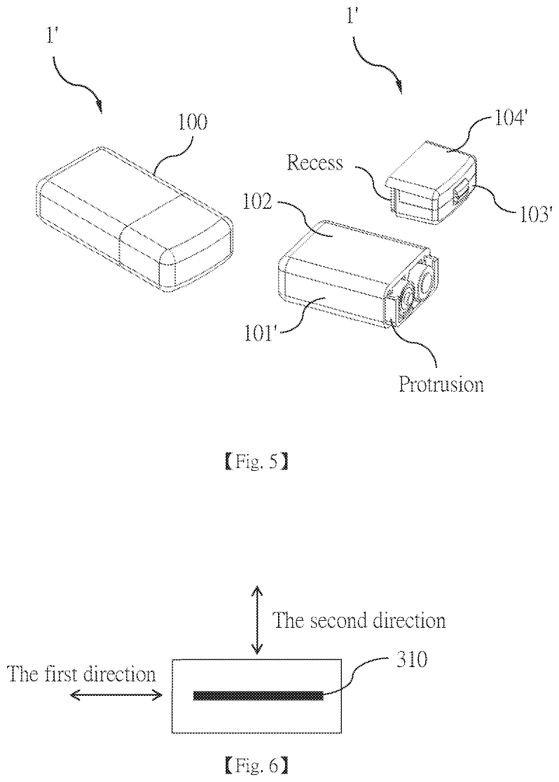

FIG. 6 is a schematic diagram of the operation of the handheld rapid heating device for cutting and adhering a thin film, according to an embodiment of the present invention.

Generally when the user operates the handheld rapid heating device 1 for cutting and adhering a thin film of the present invention, the user moves the electrically heating wire 310 along the first direction to scratch across the thin film for the cutting and heat sealing. In this circumstance, the area where the electrically heating wire applied on the thin film may be smaller. However, the user still can move the electrically heating wire 310 along the second direction to scratch across the thin film for the cutting and heat sealing. In this circumstance, the area where the electrically heating wire 310 applied on the plastic thin film may be larger, and thus, for the thin films with different thickness or made by different materials, the user can choose to move the electrically heating wire 310 along different directions. The first direction and the second direction are not in parallel, for example, they are perpendicular to each other, but not limited thereto.

Although the present invention has been explained in relation to its preferred embodiment, it is to be understood that many other possible modifications and variations can be made without departing from the spirit and scope of the invention as hereinafter claimed.

What is claimed is:

1. A handheld rapid heating device for cutting and adhering a thin film, comprising:
a housing, formed with an opening;
a power supply module, arranged in the housing; and
an electric heating module, receiving power from the power supply module and comprising an electrically heating wire; the electrically heating wire extending at least partially out of the opening of the housing, and being configured to be suitable for heating and thus melting an area of at least one thin film.

2. The handheld rapid heating device for cutting and adhering a thin film of claim 1, wherein a power of the electrically heating wire is set to provide a heating temperature that allows the melting area being cooled down and sealed in 1+0.5 seconds.

3. The handheld rapid heating device for cutting and adhering a thin film of claim 1, wherein the power of the electrically heating wire is in a range of 3 W to 7 W.

4. The handheld rapid heating device for cutting and adhering a thin film of claim 3, wherein a voltage of the electrically heating wire is in a range of 2.4 V to 6.0 V.

5. The handheld rapid heating device for cutting and adhering a thin film of claim 1, wherein the electrically heating wire is a round wire or a flat wire; a diameter of the round wire is in a range of 0.16 mm to 0.36 mm, and a diameter of the flat wire is in a range of 0.4 mm to 1.4 mm.

6. The handheld rapid heating device for cutting and adhering a thin film of claim 5, wherein a length of the electrically heating wire is inversely proportional to square of the diameter of the wire.

7. The handheld rapid heating device for cutting and adhering a thin film of claim 5, wherein a length of the electrically heating wire is 30±10 mm.

8. The handheld rapid heating device for cutting and adhering a thin film of claim 1, wherein the housing comprises a lower housing, and/or an upper housing, and/or a front housing, and/or a front lid.

9. The handheld rapid heating device for cutting and adhering a thin film of claim 8, wherein any combination of the lower housing, the upper housing, the front housing, or the front lid is integrally formed.

10. The handheld rapid heating device for cutting and adhering a thin film of claim 8, wherein the lower housing and the upper house constitute a rear housing module; the front housing and the front lid constitute a front housing module, and the front housing module is removably installed on the rear housing module.

11. The handheld rapid heating device for cutting and adhering a thin film of claim 8, wherein the housing comprises a retractable structure to let the electrically heating wire of the electric heating module move out of or move back into the opening of the housing.

12. The handheld rapid heating device for cutting and adhering a thin film of claim 1, wherein the power supply module is a one-time battery cell, or a rechargeable battery cell, or a linear power supply circuit, a switch power supply circuit, or a programming power supply circuit that are connected to an outer power supply in a wire or wireless way.

13. The handheld rapid heating device for cutting and adhering a thin film of claim 1, further comprising a first connection piece, connected to a first end of the power supply module; and a second connection piece, connected to a second end of the power supply module, wherein the second connection piece is directly or indirectly connected to the electric heating module.

14. The handheld rapid heating device for cutting and adhering a thin film of claim 13, wherein the first connection piece is a double-contact piece, connected to the first end and a third end of the power supply module; the second connection piece is a single-contact piece, connected to the second end and a fourth end of the power supply module.

15. The handheld rapid heating device for cutting and adhering a thin film of claim 1, further comprising a switch spring, connected between the power supply module and the electric heating module and turning on or turning off the power of the electric heating module according to a pressure passing through the electrically heating wire.

16. The handheld rapid heating device for cutting and adhering a thin film of claim 15, wherein the switch spring has a trigger pressure, and when a pressure passing through the electrically heating wire is higher than the trigger pressure, the power becomes enabled to supply to the electric heating module.

17. The handheld rapid heating device for cutting and adhering a thin film of claim 16, wherein the trigger pressure of the switch spring is 80 cN±25 cN.

18. The handheld rapid heating device fir cutting and adhering a thin film of claim 1, further comprising a switch, disposed on the housing and connected between the power supply module and the electric heating module.

19. The handheld rapid heating device for cutting and adhering a thin film of claim 1, wherein the handheld rapid heating device for cutting and adhering a thin film is a handheld one or a portable one; the maximum length is in a range of 80 mm to 140 mm, the maximum width is in a range of 40 mm to 80 mm.

20. An operation method for the handheld rapid heating device for cutting and adhering a thin film of claim 1, wherein the electrically heating wire moves along a first direction or a second direction, and the first direction is not in parallel with the second direction.
